(19) United States
(12) Patent Application Publication
(10) Pub. No.: US 2007/0079064 A1
(43) Pub. Date: Apr. 5, 2007

(54) Disk cache control apparatus

(75) Inventors: Akihito Kobayashi, Kawasaki (JP); Hidenori Yamada, Kawasaki (JP); Katsuhiko Nagashima, Kawasaki (JP); Mikio Ito, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 11/319,598

(22) Filed: Dec. 29, 2005

(30) Foreign Application Priority Data
Sep. 30, 2005 (JP) 2005-288018

(51) Int. Cl. G06F 13/00

(52) U.S. Cl. 711/113

(57) ABSTRACT

In order to provide a disk cache control apparatus allowing an upper level apparatus to carry out a high speed access even if the upper level apparatus accesses a discretionary area of a logical volume, the disk cache control apparatus comprises at least a data storage unit for storing data read out of a lower level apparatus temporarily or for a predefined time, a management information storage unit for storing management information which correlates an area of a logical volume with that of the data storage unit, a management information generation unit for generating the management information, and an access processing unit for accessing data of either the data storage unit or a lower level apparatus.

### BACKGROUND OF THE INVENTION

1. Field of the Invention

The present invention relates to a disk cache control apparatus for a disk array control apparatus for performing control so as to allow an upper level apparatus to access a lower level apparatus per logical volume.

2. Description of the Related Art

A storage apparatus such as a disk array apparatus (RAID: redundant array of independent/inexpensive disks) is equipped with a cache memory for speeding up processing, thereby carrying out Read/Write I/O processing (simply called “access” hereinafter) without reading from, or writing to, a disk.

And a storage apparatus such as a disk array apparatus is generally controlled so as to allow a host computer (a CPU of an upper level apparatus) to access a disk array per logical volume (simply called a “LUN” (Logical Unit Number) hereinafter).

Since a cache memory is of a smaller capacity than a LUN retained by a disk array apparatus, it is efficiently used by ejecting infrequently used data, et cetera, by writing it back to a disk.

Therefore, if a read I/O is issued for data nonexistent in, or ejected from, the cache memory, it is necessary to read from the disk at every such time, hence resulting in a degraded I/O response.

Also, there are cases where a LUN requires a high speed processing despite a low frequency usage, or a LUN requires a high speed processing without being influenced by the load of other LUNs.

In order to respond to the above described problem, the Bind In Cache function is widely used.

The Bind In Cache function is a function for a high speed processing by assigning a certain area of a LUN in a specific area of a cache memory in advance and making data to be processed for the aforementioned area resident in the cache memory.

FIG. 1 shows the concept of the Bind In Cache function.

FIG. 1 shows that an area A of a LUN 70 is allocated to a special area A′ of a cache memory 71. And the data in the area A, which is read out of a lower level apparatus (e.g. a disk apparatus constituting a disk array apparatus) by a staging processing, et cetera, is stored in the special area A′, and is thereby resident therein.

Accordingly, if a Read/Write I/O request is made to the area A of the LUN 70 from an upper level apparatus such as a host computer, the processing will always be carried out for the special area A′ of the cache memory 71.

That is, there is no longer a need to access to a lower level apparatus storing the data of the area A of the LUN 70, hence enabling a high speed processing.

The above described Bind In Cache function is very effective in the case of an accessed area being well defined and a high speed processing being required for the entirety of the area.

However, if an access area for the LUN 70 is distributed or the access range is dynamically changed, it is not necessarily effective (e.g., in a file access an access range depends on a file system in the Open system).

FIG. 2 describes a LUN 80 and a cache memory 81 in the case of an access range dynamically changing.

As shown by FIG. 2, an access is conducted from an upper level apparatus to a discretionary (random) area such as areas B, C or D of the LUN 81 in a file access processing in an Open system. Since the capacity of the cache memory 81 is generally smaller than that of the LUN 80, the area D cannot be allocated in the cache memory 81 for instance (that is, data of the areas B and C are resident in the specific areas B′ and C′, while data of the area D cannot be resident in the cache memory 81).

In such a case, since it is difficult to designate ranges in the cache memory 81 to allow data to be held resident, in advance, it is necessary to assign the cache memory to a certain range (e.g., in the units of LUNs or slices).

Due to this, there have been problems such as the Bind In Cache function requiring many more pieces of cache memory 81 than is essentially necessary, and apossible case of it being difficult to obtain a cache memory 81 per se for a Bind In Cache use if the capacities of a LUN or a slice are larger than the equipped cache memory 81 may occur.

For the above described reasons an effective use of the Bind In Cache function has been precluded, making it difficult for an upper level apparatus to perform an access at a high speed.

A laid-open Japanese patent application publication No. 09-204358 has disclosed a disk cache management apparatus for improving an access performance drastically by controlling a block allocation of a disk cache in the unit of files.

A laid-open Japanese patent application publication No. 2002-108704 has disclosed a disk cache control system for using a disk cache effectively by designating an appropriate disk cache mode for a file access mode.

### SUMMARY OF THE INVENTION

In consideration of the above problem, the challenge of the present invention is to provide a disk cache control apparatus enabling an upper level apparatus to perform an access at a high speed even in the case of the upper level apparatus performing an access to a random area of a logical volume.

In order to solve the above described problem, a disk cache control apparatus, according to the present invention, for a disk array control apparatus which performs control to allow an upper level apparatus to access a lower level apparatus per logical volume, comprising: a data storage unit for storing data requested from the upper level apparatus by reading from the lower level apparatus; a management information storage unit for storing management information which correlates an area of the logical volume with that of the data storage unit; a management information generation unit for generating the management information which allocates, to an area for making the data resident within a predetermined range of the data storage unit, an area of the logical volume for a discretionary piece of data that has been requested from an upper level apparatus, until all areas of the allocated logical volume become a predefined size; and an access processing unit for obtaining a storage place of data requested by the upper level apparatus from the management information and carrying out a read/write processing for the data stored in the obtained storage place.

The present invention is configured to allocate an area of a logical volume in an area for making data resident, which is an area within a predetermined range of the data storage unit, thereby making data resident in the aforementioned area, and therefore it is possible to carry out a read/write processing of data for the aforementioned data by an access processing unit.

And the management information generation unit generates the management information until all areas of the logical volume allocated to an area for making a discretionary data resident, which has been requested by the upper level apparatus, become a predefined size, and therefore it is possible to improve access speeds until the total size of areas of the logical volume to be accessed by the upper level apparatus becomes the predetermined size, instead of depending on the area of the logical volume accessed by the upper level apparatus.

That is, even in the case of the upper level apparatus accessing a discretionary area of the logical volume, the aforementioned access can be carried out at a high speed.

And the present invention can also provide the same benefits of a disk array control method which performs control to allow an upper level apparatus to access to a lower level apparatus per logical volume, wherein a disk cache control method makes a disk array control apparatus carry out the steps of generating the management information for allocating an area of the logical volume to an area for making the data resident within a predetermined range of the data storage unit which stores a discretionary piece of data that has been requested by an upper level apparatus by reading it out of the lower level apparatus, until all areas of the allocated logical volume become a predefined size; and obtaining a storage place of data requested by the upper level apparatus from the management information and carrying out a read/write processing for the data stored in the obtained storage place.

As described above, the present invention is capable of providing a disk cache control apparatus allowing an upper level apparatus to access at a high speed, even in the case of the upper level apparatus accessing a discretionary area of the logical volume.

### BRIEF DESCRIPTION OF THE DRAWINGS

FIG. 1 shows a concept of a Bind In Cache function;

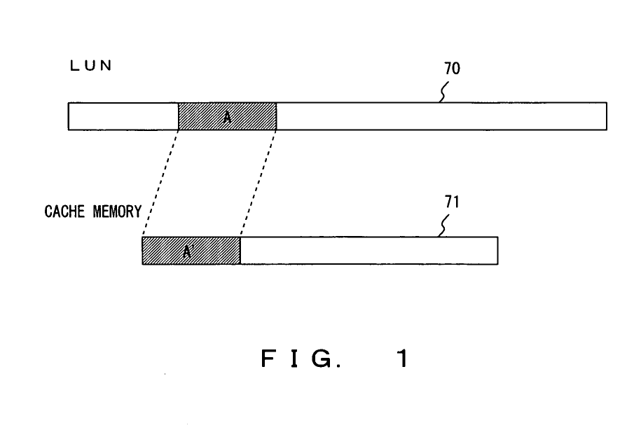

FIG. 2 describes a LUN and a cache memory in the case of access ranges changing dynamically;

FIG. 3 shows the principle of the present invention;

FIG. 4 describes a file access processing in the open system according to an embodiment of the present invention;

FIG. 5 exemplifies a comprisal of a RAID apparatus according to an embodiment of the present invention;

FIG. 6 describes a disk cache control according to an embodiment of the present invention;

FIG. 7 exemplifies a LUN BIND target management table according to an embodiment of the present invention; and

FIG. 8 is a flow chart showing a disk cache control processing according to an embodiment of the present invention.

### DESCRIPTION OF THE PREFERRED EMBODIMENTS

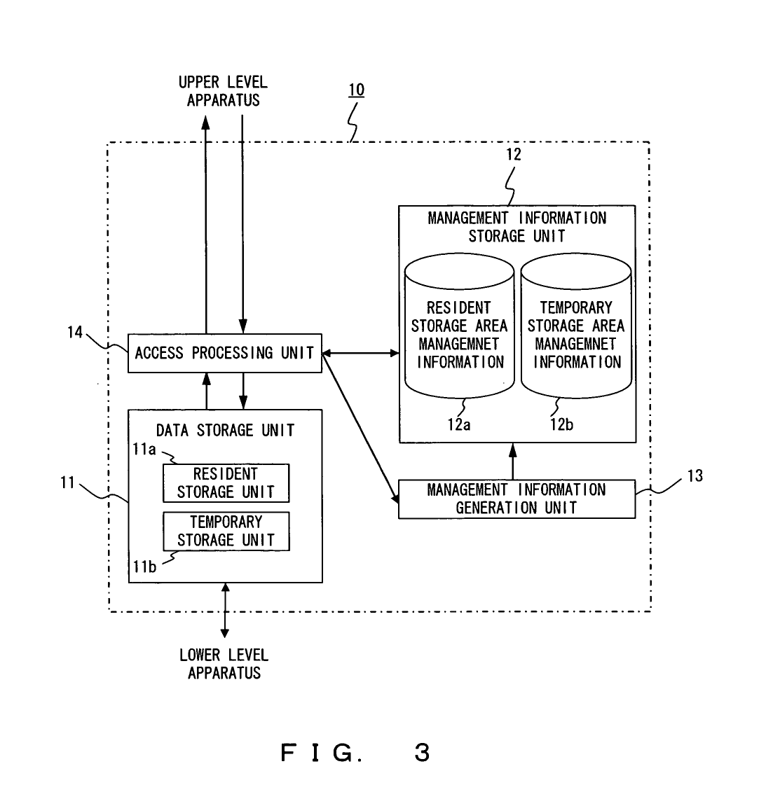

The following is a detailed description of the preferred embodiment of the present invention based on FIGS. 3 through 8.

FIG. 3 shows the principle of the present invention.

A disk cache control apparatus 10 shown by FIG. 3 comprises at least a data storage unit 11 for storing data read out of a lower level apparatus, a management information storage unit 12 for storing management information which correlates an area of a logical volume with that of the data storage unit 11, a management information generation unit 13 for generating the management information, and an access processing unit 14 for accessing data of either the data storage unit 11 or a lower level apparatus.

The data storage unit 11 is a storage unit for storing data read out of a lower level apparatus on an as required basis such as for frequently accessed data. The data storage unit 11 comprises a resident storage unit 11a for making data resident and a temporary storage unit 11b for storing data temporarily or for a predefined period of time.

Management information stored by the management information storage unit 12 comprises resident storage area management information 12a for correlating an area of a logical volume and that of the resident storage unit 11a, and temporary storage area management information 12b for correlating an area of a logical volume and that of the temporary storage unit 11b.

The management information generation unit 13 generates the resident storage are a management information 12a or temporary storage area management information 12b according to an instruction of the access processing unit 14 to store in the management information storage unit 12. The management information generation unit 13 also generates a predetermined amount of resident storage area management information 12a, and when exceeding the predetermined amount thereof, generates the temporary storage area management information 12b only.

The access processing unit 14, having received a Read/Write I/O request for an area of a logical volume from an upper level apparatus, checks the applicable management information by referring to the management information storage unit 12.

And the access processing unit 14 obtains, from the applicable management information, the area of the data storage unit 11 storing the data of the Read/Write I/O request, and accesses the applicable area.

On the other hand, if the applicable management information does not exist, the access processing unit 14 reads the applicable data from a lower level apparatus to store in the data storage unit 11 and at the same time judges as to which of the two units, i.e., the resident storage unit 11a or temporary storage unit 11b, the applicable data is to be stored in and makes the management information generation unit 13 generate new management information.

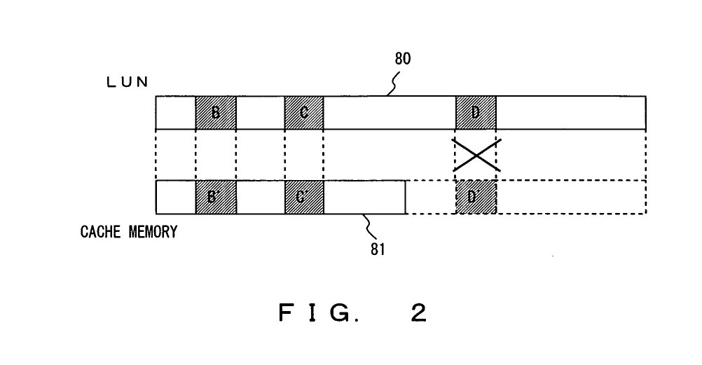

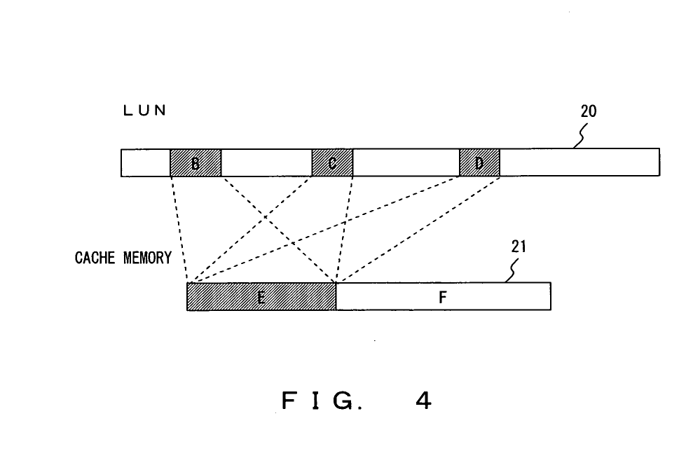

FIG. 4 illustrates the preferred embodiment according to the present invention as described above. FIG. 4 exemplifies a file access processing in the Open system as with FIG. 2.

As shown by FIG. 4, an access is carried out from an upper level apparatus to a discretionary area such as the area B, C or D of the LUN 20 in a file access processing in the Open system.

Meanwhile, a cache memory 21 according to the present embodiment comprises a resident storage area E for accomplishing the Bind In Cache function and the other temporary storage area F. The resident storage area E is a continuous area with a predefined capacity whose capacity is determined by the capacity of an area requiring the Bind In Cache function among the areas accessed by a LUN.

For instance, if it is required to use the Bind In Cache function for the capacity of a total of the areas B, C and D, the resident storage area E is set to the capacity of the aforementioned total thereof.

As an upper level apparatus accesses the areas B, C and D, the management information generation unit 13 generates, and stores in the management information storage unit 12, respective pieces of resident storage area management information which correlate the areas B, C and D and predefined areas within the resident storage area E, respectively.

Therefore, even in the processing of accessing a discretionary area of the LUN such as a file access processing in the Open system, it is possible to accomplish the Bind In Cache function by an effective use of a cache memory, resulting in enabling the upper level apparatus to access at a high speed.

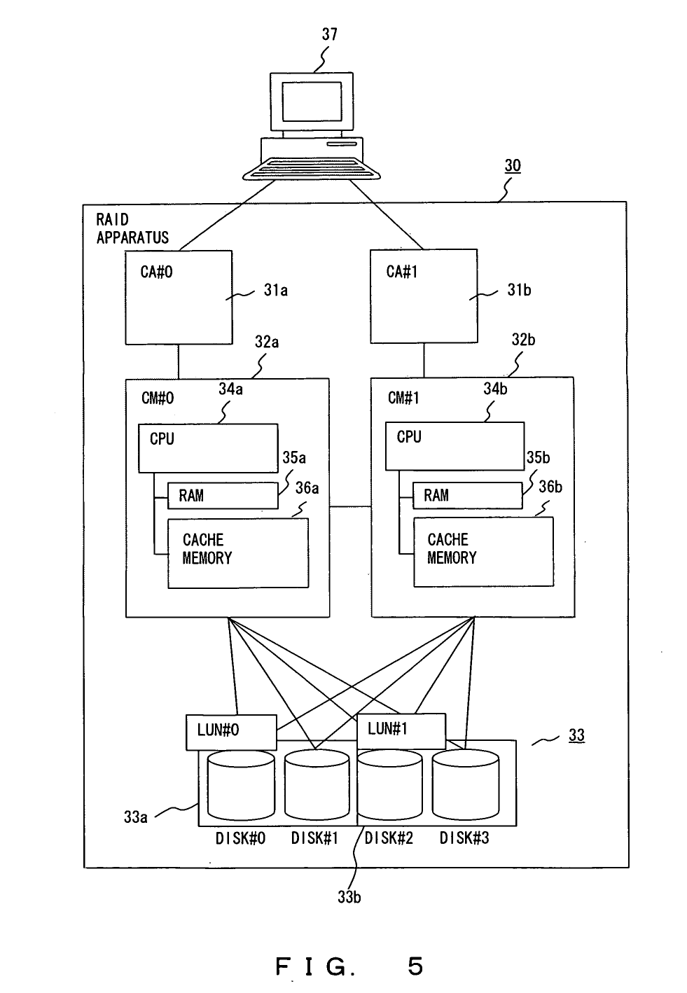

FIG. 5 exemplifies a comprisal of a RAID apparatus according to an embodiment of the present invention.

The RAID apparatus 30 shown by FIG. 5 at least comprises a CM 32a, i.e., a RAID control apparatus, connected to a host computer 37 by way of a CA (channel adapter) 31a and a disk array 33 connected to the CM 32a by way of a router (not shown herein), et cetera.

And the present embodiment further comprises a CM 32b, i.e., a RAID control apparatus, connected to both the host computer 37 by way of a CA 31b and the disk array 33 by way of a router (not shown herein), et cetera, the CM 32a and CM 32b being connected to each other by way of a router (not shown herein), et cetera.

Note here that the present embodiment exemplifies a case of the RAID control apparatuses (i.e., CM 32a and CM 32b) being dualized, however there is no intention of limiting it as such. A redundant configuration of higher degree than a dualization, or a singular configuration by using just a CM 32a, may also be applicable.

The CA 31a is an interface between an I/O (input/output) apparatus (not shown herein) comprised by the host computer 37 and CM 32a, performing control of a command and data between the host computer 37 and CM 32a.

The CM 32a at least comprises a CPU (central processing unit) 34a, a RAM (random access memory) 35a and a cache memory 36a. The disk cache control apparatus according to the present embodiment is accomplished by the CM 32a.

And making the CPU 34a operate according to a prescribed program controls an I/O processing (e.g., cache control) of the host computer 37 and the entirety of the RAID apparatus 30, and accomplishes the management information generation unit 13 and access processing unit 14.

And the data storage unit 11 is accomplished by the cache memory 36a, while the management information storage unit 12 is accomplished by the RAM 35a.

The disk array 33 comprises two logical volumes LUNs #0 and#1. The LUN#0 is accomplished by the disk array 33a including magnetic disk apparatuses Disk #0 and #1 and the LUN #1 is accomplished by the disk array 33b including magnetic disk apparatuses Disk #2 and #3.

Here, the disk array apparatus 33 according to the present embodiment comprises a RAID 1, but there is no intention of limiting it as such. That is, the RAID may be configured to a required level (e.g., RAID 0 through 5).

The above described configurations of the CA 31a and CM 32a are the same for the CA 31b and CM 32b, respectively, and therefore descriptions thereof are omitted herein.

The CM 32a and CM 32b are connected to each other by a router (not shown herein), and when update data is sent over from the host computer 37 to the CM 32a by way of the CA 31a for example, the CPU 34a stores the update data in the cache memory 36a and at the same time transmits the update data to the CM 32b by way of a router (not-shown). And the CM 32b stores the update data in the cache memory 36a, thereby both the cache memory 36a within the CM 32a and the cache memory 36b within the CM 32b always store the same data.

The above described processes make the CM 32a and CM 32b dualized (or redundant) . Accordingly the following description is of the operations of CA 31a, CM 32a and disk array 33a to simplifying the description.

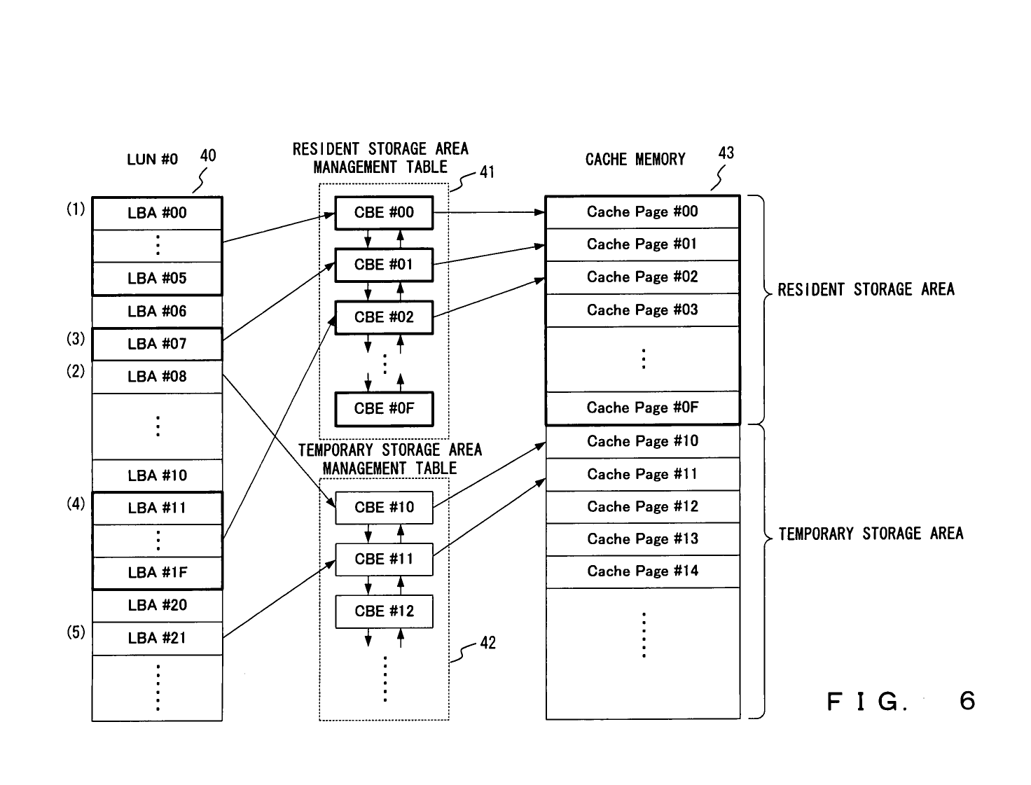

FIG. 6 describes a disk cache control according to an embodiment of the present invention. Note that the LBA number, CBE number and Cache Page number shown by FIG. 6 are shown in hexadecimal, e.g., the LBA #10 indicating an LBA #16 in decimal.

A LUN 40 shows an example of the LUN #0 shown by FIG. 5. An access to the LUN 40 from the host computer 37 is performed per the LBA (logical block address). For example, the host computer 37 requests the RAID apparatus 30 for a Read/Write I/O by designating six blocks of data starting from the LBA #00.

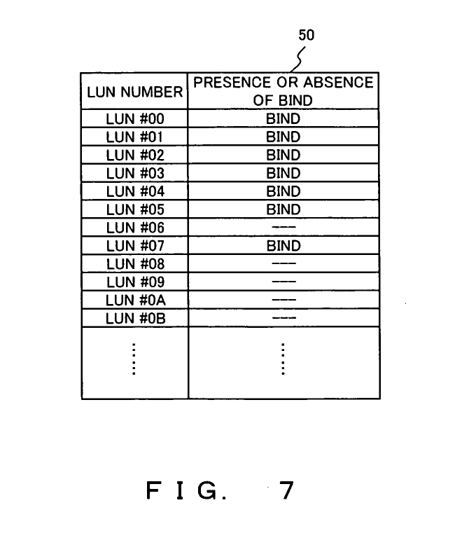

And the areas of the LUN40 bordered by bold lines (e.g. LBA #00 through #05) indicate the areas to be allocated (called a “LUN BIND target” hereinafter) as the resident storage areas of the cache memory 43. Note that whether or not the LUN 40 is a LUN BIND target is determined by a LUN BIND target management table 50 which is set up in advance. The LUN BIND target management table 50 is shown by a later described FIG. 7.

A resident storage area management table 41 and temporary storage area management table 42 are respectively constituted by a plurality of CBEs (Cache Bundle Element). The CBEs constituting the resident storage area management table 41 are called “resident storage area-use CBE” and the ones constituting the temporary storage area management table 42 are called “temporary storage area-use CBE” hereinafter.

The number of the resident storage area-use CBEs is a predetermined finite number which is determined by an area size of the LUN 40 as a LUN BIND target.

Here, the CBE is a management table for managing a Cache Page constituting the cache memory 43, with one corresponding CBE existing per Cache Page. Each CBE comprises for example a LUN number and an LBA number which together indicate a data storage place in a logical volume and information which retains an address of a Cache Page allocated as the aforementioned storage place and a presence or absence of Dirty Data (in the unit of blocks) within the aforementioned Cache Page.

Meanwhile, each CBE is interrelated with one another in a structure capable of accomplishing a FIFO (first in first out).

And the CPU 34a generates the resident storage area-use CBE if the area of the LUN 40 accessed is a LUN BIND target, while generates the temporary storage area-use CBE if the area of the LUN 40 accessed is a temporary storage area (i.e., an area other than the one of the LUN BIND target).

For example, if the host computer 37 has accessed in the sequence of the area (1) (e.g., LBAs #00 through #05), area (2) (e.g., LBA #08), area (3) (e.g., LBA #07), area (4) (e.g., LBAs #11 through#1F) and area (5) (LBA#21), then the CPU 34a generates the resident storage area-use CBE #00, CBE #01 and CBE #02 for the LUN BIND target areas (1), (3) and (4), respectively, while generating the temporary storage area-use CBE #08 and CBE #21 for the areas other than the LUN BIND target, i.e., the areas (2) and (5).

Since the cache memory 43 generally has a smaller storage capacity compared to the disk array 33, it is not possible to store all data in the cache memory 43. Accordingly an ejection is carried out for an infrequently used CBE byusing an LRU (least recently used) algorithm. That is, the applicable CBE is released. Note that the LRU algorithm is a known technique commonly used for managing a cache memory, and therefore a description thereof is omitted herein.

Here, what is ejected is the CBE(s) of the temporary storage area management table 42 and not the one of the resident storage area management table 41.

By so doing, a cache hit is expected for the resident storage area-use CBE if an I/O load is high without being influenced thereby.

Note that the present embodiment can judge a presence or absence of a cache hit by a presence or absence of a CBE. That is, if an applicable CBE exists, it is possible to judge the storing the applicable data in the cache memory 43.

The cache memory 43 is constituted by a plurality of Cache Pages and segregated between the resident storage area and temporary storage area (i.e., areas other than the resident storage area).

Each Cache Page is managed in 128 block units by adding 8-byte BCC (block check code) to each block (512 bytes). Therefore, one Cache Page has 66,560 bytes in the present embodiment.

Here, the resident storage area and temporary storage area of the cache memory 43 shown by FIG. 6 show the case of the each being a continuous area, but there is no intention to limit as such, and rather may be discontinuous areas.

FIG. 7 exemplifies a LUN BIND target management table 50 according to an embodiment of the present invention.

The LUN BIND target management table 50 shown by FIG. 7 comprises a LUN number and a presence or absence of a LUN BIND. A “BIND” in the column “a presence or absence of BIND” indicates the applicable LUN being a LUN BIND target. And a “---” in the column “a presence or absence of BIND” indicates the applicable LUN is not a LUN BIND target.

The LUN BIND target management table 50 is stored by the RAM 35a for example. If a cache-miss occurs in an access request for a LUN from the host computer 37, the CPU 34a refers to the LUN BIND target management table 50 to determine whether or not the requested LUN for an access is a LUN BIND target.

If it is a LUN BIND target, a resident storage area-use CBE is generated in priority to allocate the applicable LBA to the resident storage area of the cache memory 43. Then, when the resident storage areas are used up for allocating an LBA, a temporary storage area-use CBE is generated to allocate the applicable LBA to the temporary storage area of the cache memory 43.

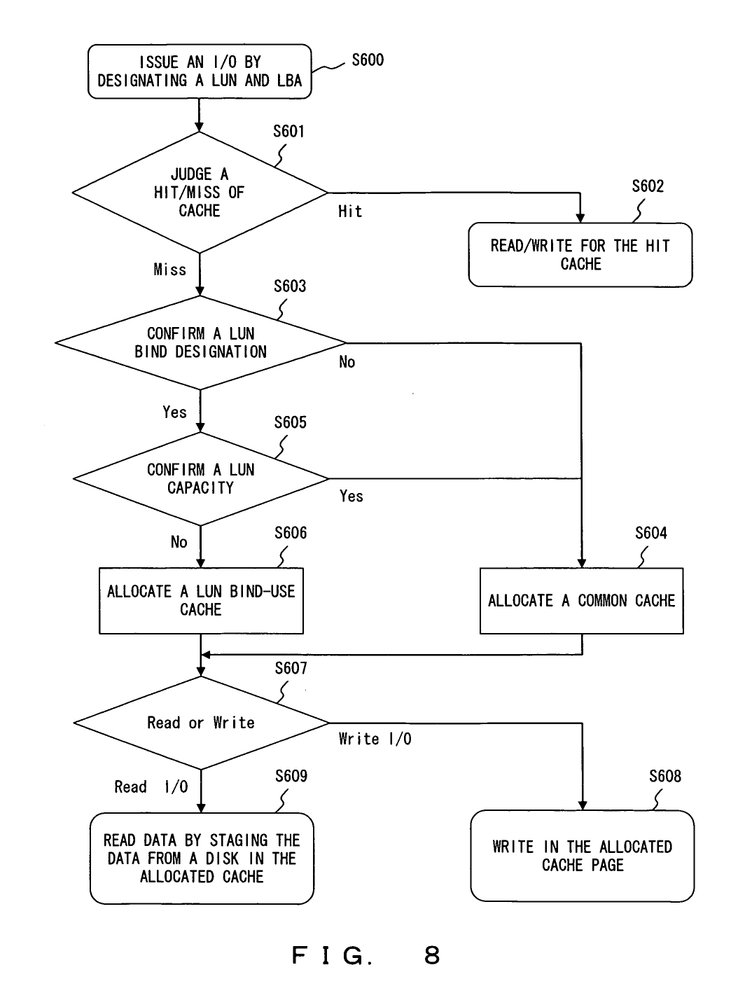

FIG. 8 is a flow chart showing a disk cache control processing according to an embodiment of the present invention.

Having received a Read/Write I/O request from the host computer 37 by designating a predefined LUN and LBA in the step S600, the CPU 34a transfers the process to the step S601.

In the step S601, the CPU 34a checks whether or not the data requested in the step 600 is stored in the cache memory 43. That is, the CPU 34a refers to the resident storage area management table 41 and temporary storage area management table 42 to check whether or not a CBE relating to the LBA requested in the step 600 is existent.

And, if the CBE relating to the applicable LBA is existent, the CPU 34a judges a cache hit (i.e., a hit) and transfers the process to the step S602 for carrying out a Read/Write processing for the hit cache memory 43.

On the other hand, if a CBE relating to the applicable LBA is not existent, the CPU 34a judges acache-miss and transfers the process to the step S603.

In the step S603, the CPU 34a refers to the LUN BIND target management table 50 stored at a predefined address of the RAM 35a, and checks whether or not the LUN designated in the step S600 is a LUN BIND target.

If the applicable LUN is not a LUN BIND target, the CPU 34a transfers the process to the step S604 and allocates a temporary storage area of the cache memory 43 to the LBA of the applicable LUN (i.e., generates a temporary storage area-use CBE).

On the other hand, if the applicable LUN is a LUN BIND target, the CPU 34a transfers the process to the step S605 and confirms the total capacity of the LUN (called a “LUN BIND allocation capacity” hereinafter) which is allocated to the resident storage area of the cache memory 43.

Note that the CPU 34a integrates an applicable allocation capacity of the LUN BIND allocation capacity to store at a predefined address of the RAM 35a (or stored in a nonvolatile memory such as an EPROM) when assigning the LBA designated in the step S600 to a resident storage area of the cache memory 43 (in the step S606).

And the CPU 34a compares the LUN BIND allocation capacity with a predetermined capacity (called a “LUN BIND reference capacity” hereinafter) and, if the LUN BIND allocation capacity exceeds the LUN BIND reference capacity, transfers the process to the step S604 and assigns the applicable LBA to the temporary storage area of the cache memory 43.

On the other hand, if the LUN BIND allocation capacity does not exceed the LUN BIND reference capacity, the CPU 34a transfers the process to the step S606 and allocate a resident storage area of the cache memory 43 to the applicable LBA (i.e., generates a resident storage area-use CBE).

Having assigned the applicable LBA to the cache memory 43 by the processing of the step S604 or S606, the CPU 34a transfers the process to the step S607.

In the step S607, if the Read/Write I/O request issued by the host computer 37 in the step S600 was a Write request, the CPU 34a transfers the process to the step S608 and carries out a Write processing for the cache memory 43 allocated in the step S604 or S606, thus ending the process.

Meanwhile, if the Read/Write I/O request issued by the host computer 37 in the step S600 was a Read request, the CPU 34a transfers the process to the step S609 and carries out a staging processing for the cache memory 43 allocated in the step S604 or S606 and at the same time a Read processing therefor, thus ending the process.

As described above, the disk cache control apparatus 10 according to the present embodiment, if an upper level apparatus accesses a LUN area of the LUN BIND target (i.e., a cache-miss), assigns the aforementioned LUN area to a resident storage area of the cache memory 43 independent of the LUN area being accessed by the upper level apparatus, and therefore it is possible to process an access from an upper level apparatus at high speed even in the case of the upper level apparatus accessing a discretionary area of a LUN.

And since a LUN area of a LUN BIND target which is accessed by the upper level apparatus is allocated to a resident storage area of the cache memory 43 up to a predefined size, an effective use of a cache memory becomes possible, thereby enabling an effective use of the Bind In Cache function even if the size of the cache memory 43 is smaller than that of the LUN. Accordingly, it is possible to process an access from the upper level apparatus at a high speed.

What is claimed is:

1. A disk cache control apparatus for a disk array control apparatus which performs control to allow an upper level apparatus to access to a lower level apparatus per logical volume, comprising:
a data storage unit for storing data requested by the upper level apparatus by reading from the lower level apparatus;
a management information storage unit for storing management information which correlates an area of the logical volume with that of the data storage unit;
a management information generation unit for generating the management information which allocates, to an area for making the data resident within a predetermined range of the data storage unit, an area of the logical volume for a discretionary piece of data that has been requested by an upper level apparatus, until all areas of the allocated logical volume become a predefined size; and
an access processing unit for obtaining a storage place of data requested by the upper level apparatus from the management information and carrying out a read/write processing for the data stored in the obtained storage place.

2. The disk cache control apparatus according to claim 1, wherein
said management information comprises
resident storage area management information for correlating an area of said logical volume with an area for making said data resident within a predetermined range of said data storage unit, and
temporary storage area management information for correlating an area of the logical volume with an area, which stores the data either temporarily or for a predefined period of time, outside of the predetermined range of the data storage unit, wherein
the disk cache control apparatus
generates either one of management information, i.e., the resident storage area management information or the temporary storage area management information, and at the same time reads the data from a lower level apparatus to store it in an area of the data storage unit allocated by the management information.

3. The disk cache control apparatus according to claim 1, wherein
said data storage unit comprises
a resident storage unit for reading data, requested by said upper level apparatus from said lower level apparatus, and making it resident, and
a temporary storage unit for reading data, requested by the upper level apparatus from the lower level apparatus, and storing it temporarily or for a predefined period of time.

4. A disk array control method which performs control to allow an upper level apparatus to access a lower level apparatus per logical volume, wherein
a disk cache control method makes a disk array control apparatus carry out the steps of
generating the management information for allocating an area of the logical volume to an area for making the data resident within a predetermined range of the data storage unit which stores a discretionary piece of data that has been requested by an upper level apparatus by reading it from the lower level apparatus, until all areas of the allocated logical volume become a predefined size; and
obtaining a storage place of data requested by the upper level apparatus from the management information and carrying out a read/write processing for the data stored in the obtained storage place.

5. A recording medium for a program for accomplishing a disk array control which performs control to allow an upper level apparatus to access a lower level apparatus per logical volume, wherein
a disk cache control method makes a disk array control apparatus carry out the steps of
generating the management information for allocating an area of the logical volume to an area for making the data resident within a predetermined range of the data storage unit which stores a discretionary piece of data that has been requested by an upper level apparatus by reading it from the lower level apparatus, until all areas of the allocated logical volume become a predefined size; and
obtaining a storage place of data requested by the upper level apparatus from the management information and carrying out a read/write processing for the data stored in the obtained storage place.
